(19) United States
(12) Patent Application Publication
(10) Pub. No.: US 2015/0323048 A1
(43) Pub. Date: Nov. 12, 2015

(54) ADJUSTABLE STROKE SLIDE

(71) Applicant: TECH RIM STANDARDS, LLC, Auburn Hills, MI (US)

(72) Inventors: TODD M. CLEES, GRAND BLANC, MI (US); MAREK P. BIECIUK, SHELBY TOWNSHIP, MI (US)

(73) Assignee: TECH RIM STANDARDS, LLC, Auburn Hills, MI (US)

(21) Appl. No.: 14/274,098

(22) Filed: May 9, 2014

(51) Int. Cl. F16H 25/18; F16H 35/00

(52) U.S. Cl. CPC F16H 25/183; F16H 35/00; F16H 2035/006

(57) ABSTRACT

A number of variations may include a product comprising: an adjustable stroke slide device comprising: a frame; a first and second shock absorber coupled to opposing ends of the frame; a first and a second rail system coupled to opposing sides of the frame; an adjustable slide bar system interposed between the first and the second rail; and a mounting plate coupled to the first and second rail systems and the adjustable slide bar system.

### TECHNICAL FIELD

The field to which the disclosure generally relates to includes linear motion devices.

### BACKGROUND

Any number of devices may require linear motion.

### SUMMARY OF ILLUSTRATIVE VARIATIONS

A number of variations may include a product comprising: a stroke slide device comprising: a frame; a first and a second shock absorber coupled to opposing ends of the frame; a first and a second rail system coupled to opposing sides of the frame; an adjustable slide bar system interposed between the first and the second rail; and a mounting plate coupled to the first and second rail systems and the adjustable slide bar system.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of an adjustable stroke slide device according to a number of variations.

FIG. 2 illustrates a perspective view of an adjustable stroke slide device according to a number of variations.

FIG. 3 illustrates a close-up perspective view of an adjustable stroke slide device according to a number of variations.

FIG. 4 illustrates a perspective view of an adjustable stroke slide device according to a number of variations.

FIG. 5 illustrates a perspective view of an adjustable stroke slide device according to a number of variations.

FIG. 6 illustrates a partial perspective view of an actuator and actuator shaft according to a number of variations.

### DETAILED DESCRIPTION OF ILLUSTRATIVE VARIATIONS

The following description of the variations is merely illustrative in nature and is in no way intended to limit the scope of the invention, its application, or uses.

Any number of devices may require linear motion including, but not limited to, mechanical assembly and/or welding equipment. In any number of variations, the device may require a specific stroke which may be controlled by an adjustable stroke slide device 20. The use of the adjustable stroke slide device 20 may reduce or eliminate the need for several different stroke slide devices which each provide a different stroke.

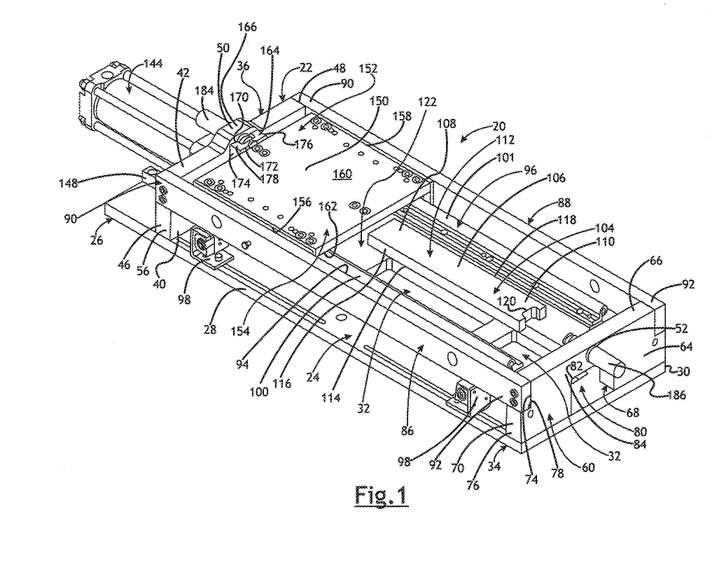

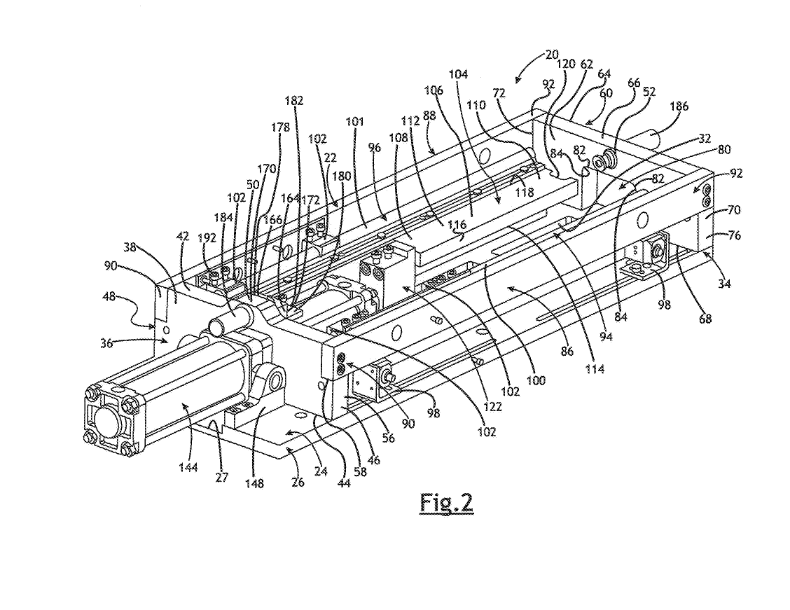

Referring to FIGS. 1-2, in a number of variations, an adjustable stroke slide device 20 may include a frame 22. The frame 22 may comprise a base plate 24, a front wall 36, a rear wall 60, a first side wall 86, and a second side wall 88.

In a number of variations, the base plate 24 may comprise a first end 26, a second end 34, a first side 28, and a second side 30. The first end 26 may be constructed and arranged to accommodate an actuator 144 and/or one or more actuator trunnions or mounting brackets 148. In a number of variations, the first end 26 may include a cutout 27 which may be constructed and arranged to accommodate the actuator 144, for example as illustrated in FIG. 2. The base plate 24 may include one or more cutouts 32 which may be any of a number of shapes including, but not limited to, square or rectangular.

In a number of variations, the front wall 36 may be attached along the width of the first end 26 of the base plate 24. In a number of variations, a front wall 36 may comprise a front face 38, a rear face 40, a top face 42, a bottom face 44, a first side face 46, and a second side face 48. The top face 42 may comprise a projection 50 or raised surface approximately central of the top face 42 which may include a through-hole 52 which may extend through the front face 38 and the rear face 40 and which may be constructed and arranged to accommodate a first shock absorber 184 as will be discussed hereafter. In a number of variations, the first side face 46 may include a first surface 54, a second surface 56, and a lip 58 extending therebetween. The second surface 56 may extend a distance further than the first surface 54. The first side face 46 may be constructed and arranged to accommodate a first side wall 86 as will be discussed hereafter. The second side face 48 may be symmetrical to the first side face 46 and may be constructed and arranged to accommodate a second side wall 88 as will be discussed hereafter. The front wall 36 may be attached to the base plate 24 in any of a number of variations including, but not limited to, mechanical fasteners 192 and/or welding.

In a number of variations, the rear wall 60 may be attached along the width of the second end 34 of the base plate 24. In a number of variations, a rear wall 60 may comprise a front face 62, a rear face 64, a top face 66, a bottom face 68, a first side face 70, and a second side face 72. The first side face 70 may comprise a first surface 74, a second surface 76, and a lip 78 extending therebetween. The second surface 76 may extend a distance further than the first surface 74. The first side face 70 may be constructed and arranged to accommodate a first side wall 86 as will be discussed hereafter. The second side face 72 may be symmetrical to the first side face 70 and may be constructed and arranged to accommodate a second side wall 88 as will be discussed hereafter. A cutout 80 may extend approximately central through the bottom face 68 and may extend upward more than halfway through the front face 62 and the rear face 64. The cutout 80 may be any number of shapes including, but not limited to, rectangular. The corners 82 of the cutout 80 may each include a radius 84. The top face 66 may be substantially planar. A through-hole 52 may extend through the front face 62 and the rear face 64 adjacent the top face 66 and may be constructed and arranged to accommodate a second shock absorber 186. The rear wall 60 may be attached to the base plate 24 in any of a number of variations including, but not limited to, mechanical fasteners 192 and/or welding.

In a number of variations, the first and second side walls 86, 88 may be substantially planar and may extend a distance less than the length of the base plate 24. The first and second side walls 86, 88 may comprise a first end 90 and a second end 92. The first end 90 may be adjacent the lip 58 and the first surface 54 of the first and second side faces 46, 48 of the front wall 36, respectively. The second end 92 may be adjacent the lip 78 and first surface 74 of the first and second side faces 70, 72 on the rear wall 60, respectively. The first and second ends 90, 92 may be attached to the front and rear wall 36, 60 in any of a number of variations including, but not limited to, mechanical fasteners 192 and/or welding.

In a number of variations, a first and second rail system 94, 96 may be attached to the frame 22. In one variation, the first and second rail systems 94, 96 may be attached to the base plate 24 along the length of the base plate 24 adjacent the first side wall 86 and the second side wall 88 respectively. The first and second rail systems 94, 96 may be attached above one or more adjustable rail brackets 98. Any number of rail systems 94, 96 may be used including, but not limited to, plain bearing linear rail systems or roller element based linear rail systems. The rail systems 94, 96 may require lubrication, or may be dry lubricated rails. The first rail system 94 may include a first rail 100 and the second rail system 96 may include a second rail 101. The first rail 100 and the second rail 101 may each include at least one linear bearing 102 which may be slideably attached to each of the rails 100, 101. The linear bearings 102 may be constructed and arranged to accommodate a mounting plate 150 as will be discussed hereafter.

In a number of variations, an adjustable slide bar system 104 may be located in between the first and second rail systems 94, 96. The adjustable slide bar system 104 may include a slide bar 106, a mounting block 122, an actuator 144, a rear stop bar 164, and a mounting plate 150.

In a number of variations, the slide bar 106 may comprise a first end 108, a second end 110, a top surface 112, a bottom surface 114, a first side surface 116, and a second side surface 118 which may each be substantially planar. The first end 108 may be constructed and arranged to attach to a mounting block 122 as will be discussed hereafter. The second end 110 may include a cutout or groove 120 which may be constructed and arranged to accommodate a second shock absorber 186 as will be discussed hereafter. The groove or cutout 120 may be any of a number of shapes including, but not limited to, a horseshoe shape.

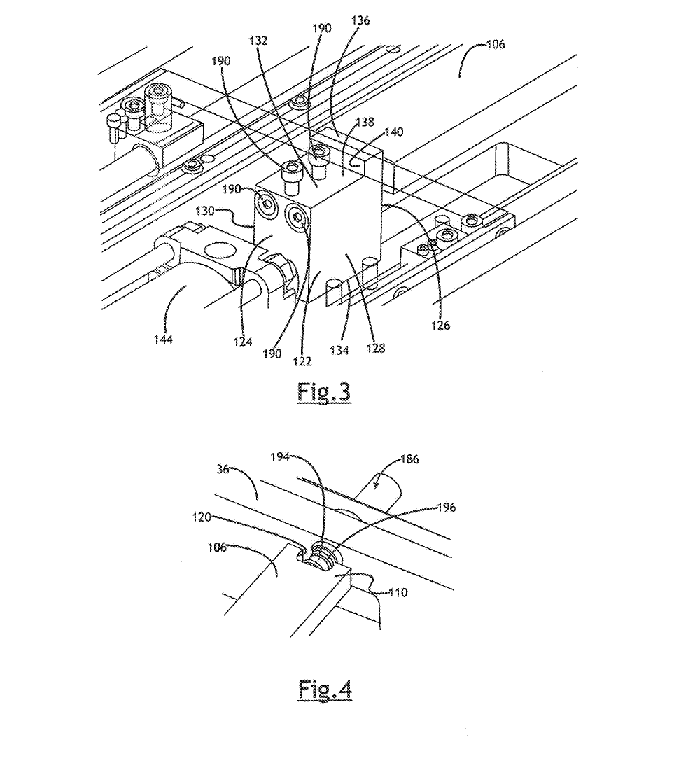

Referring to FIG. 3, in a number of variations, the mounting block 122 may comprise a front face 124, a rear face 126, a first side face 128, a second side face 130, a top face 132, and a bottom face 134. The top face 132 may include a first surface 136, a second surface 138, and a lip 140 which extends therebetween. The first surface 136 may extend a distance further than the second surface 138. The top face 132 may be constructed and arranged to accommodate a mounting plate 150 as will be discussed hereafter. The front face 124 of the mounting block 122 may be constructed and arranged to attach to an actuator 144 as will be discussed hereafter. The rear face 126 of the mounting block 122 may be constructed and arranged to attach to the first end 108 of the slide bar 106. The mounting block 122 may be attached to the slide bar 106 in any of a number of variations including, but not limited to, one or more mechanical fasteners 192 and/or welding.

Referring to FIGS. 1-2, and 6 in a number of variations, an actuator 144 may slideable house an actuator shaft 146. An actuator 144 may be powered by any of a variety of sources including, but not limited to, electricity, pneumatic, or hydraulic systems. In any number of variations, the actuator 144 may include a shaft 146 which may extend and retract in the fore and aft direction. The actuator 144 may be attached to the frame 22 in any number of variations including, but not limited to one or more trunnions or mounting brackets 148 which may be attached to the base plate 24 and/or front wall 36. The trunnions or mounting brackets 148 may be attached to the base plate 24 and/or front wall 36 in any number of variations including, but not limited to, mechanical fasteners 192 and/or welding. The actuator shaft 146 may be attached to the mounting block 122 in any of a number of variations including, but not limited to, mechanical fasteners 192 and/or welding.

Referring to FIG. 1, in a number of variations, a mounting plate 150 may comprise a front end 152, a rear end 154, a first side 156, a second side 158, a top face 160, and a bottom face 162. In a number of variations, a mounting plate 150 may be attached to the at least one linear bearing 102 on each of the first rail 100 and the second rail 101. The mounting plate 150 may also be attached to the mounting block 122 adjacent the second surface 138 and the lip 140 of the top face 132.

Referring to FIGS. 1 and 2, in a number of variations, a rear stop bar 164 may be attached to a front end 152 of the mounting plate 150. The rear stop bar 164 may comprise a top face 166, a bottom face 168, a front face 170, a rear face 172, a first side face 174, and a second side face 176. The front face 170 may be constructed and arranged to impact a first shock absorber 184. The top face 166 may comprise a first surface 178, a second surface 180, and a lip 182 which may extend therebetween and may be constructed and arranged to accommodate the mounting plate 150. The second surface 180 may extend a distance further than the first surface 178. The rear stop bar 164 may be attached to the mounting plate 150 in any of a number of variations including, but not limited to, one or more mechanical fasteners 192 and/or welding.

Referring to FIGS. 1-2, and 4, in a number of variations, a first shock absorber 184 may extend through the front plate 36 and may be constructed and arranged to accept a rear stop bar 164. A second shock absorber 186 may extend through the rear wall 60 and may be constructed and arranged to accept the second end 110 of a slide bar 106. In one variation, a shock absorber 184, 186 may include a rod 194 which may include a spring 196 wrapped around it, for example as illustrated in FIG. 4, which may lessen the impact of the rear stop bar 164 and the slide bar 106. The first and second shock absorbers 184, 186 may be attached to the frame 22 in any of a number of variations including, but not limited to, mechanical fastening and/or welding.

In a number of variations, the actuator 144 may drive the actuator shaft 146 forward which may cause the mounting block 122 to slide across the rails 100, 101 a distance in the fore direction and may cause the cutout or groove 120 in the slide bar 106 to impact the second shock absorber 186. In a number of variations, the actuator 144 may pull the actuator shaft 146 inward which may cause the mounting block 122 to slide across the rails 100, 101 in the aft direction and may cause the rear stop block 164 to impact the first shock absorber 184. This motion may provide a constant stroke. Any number of programmable logic controllers (PLC) may be used to control the speed and timing of the actuator 144. In any number of variations, the slide bar 106 may be cut and/or adjusted to a specific length which may provide any number of strokes. This may allow one linear stroke slide device to be used for several different strokes by using various length slide bars 106.

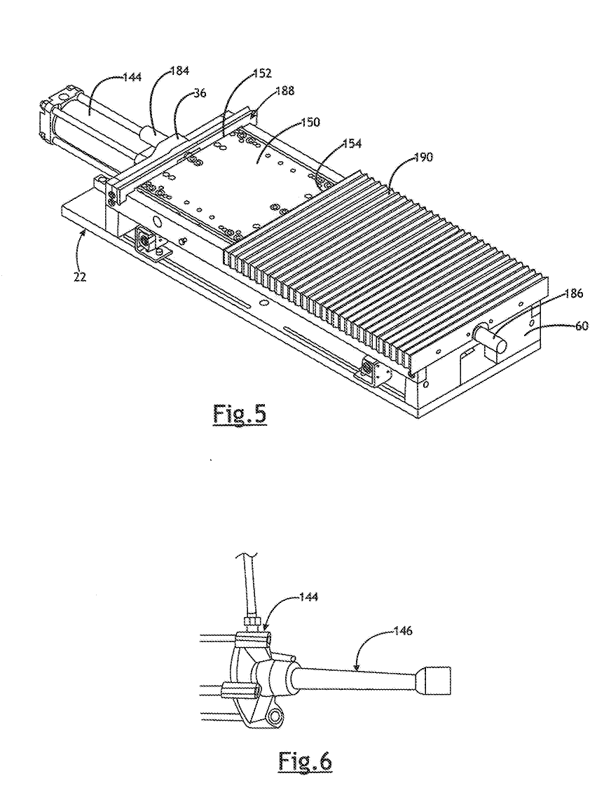

Referring to FIG. 5, in a number of variations, an optional first cover 188 and second cover 190 may be attached to the frame 22 to cover at least a portion of the adjustable slide bar system 104, the first rail system 94, the second rail systems 96, the first shock absorber 184, and/or the second shock absorber 186. The first cover 188 may attach to the frame 22 adjacent the front wall 36 and the front end 152 of the mounting plate 150 and may be constructed and arranged to prevent containments from entering into the frame 22. The first cover 188 may compress together as the mounting plate 150 moves in the aft direction and may decompress or unfold as the mounting plate 150 moves in the fore direction. The second cover 190 may be attached to the rear wall 60 and the rear end 154 of the mounting plate 150 and may be constructed and arranged to prevent containments from entering the inside of the frame 22. The second cover 190 may compress together as the mounting plate 150 moves in the fore direction and may decompress or unfold as the mounting plate 150 moves in the aft direction. The first and the second covers 188, 190 may be any of a number of shapes including, but not limited to an accordion-like bellow.

In a number of variations, any number of devices may be attached to the mounting plate 150 to provide the device with any number of specified strokes. In a number of variations, the stroke may be adjusted by changing the length of the slide bar 106.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a stroke slide device comprising: a frame; a first and a second shock absorber coupled to opposing ends of the frame; a first and a second rail system coupled to opposing sides of the frame; an adjustable slide bar system interposed between the first and the second rail; and a mounting plate coupled to the first and second rail systems and the adjustable slide bar system.

Variation 2 may include a product as set forth in Variation 1 wherein the frame comprises a base plate, a front plate, a rear plate, a first side plate, and a second side plate; wherein the front plate and the rear plate are attached to opposing ends of the base plate; and wherein the first side plate and the second side plate are attached to opposing sides of the front plate and the rear plate.

Variation 3 may include a product as set forth in any of Variations 1-2 wherein the adjustable slide system comprises an actuator; a mounting block attached to the actuator; a slide bar attached to the mounting block; a mounting plate attached to the first and the second rail systems and the mounting block; and a rear stop bar attached to the mounting plate.

Variation 4 may include a product as set forth in any of Variations 1-3 wherein the first and the second rail systems each include at least one linear bearing, and wherein the mounting plate is attached to the at least one linear bearing on each of the first and the second rail systems.

Variation 5 may include a product as set forth in any of Variations 1-4 wherein the slide bar comprises a first end and a second end, and wherein the second end comprises a cutout which is constructed and arranged to impact a shock absorber.

Variation 6 may include a product as set forth in any of Variations 1-5 wherein the first and second rail systems are dry lubricated rails.

Variation 7 may include a product as set forth in any of Variations 1-6 wherein the adjustable slide bar system is constructed and arranged to control the stroke of a mechanical device.

Variation 8 may include a product as set forth in any of Variations 1-7 further comprising a first cover.

Variation 9 may include a product as set forth in any of Variations 1-8 further comprising a second cover.

Variation 10 may include a product as set forth in any of Variations 1-9 wherein the actuator drives the mounting block, slide bar, mounting plate, and rear stop bar in a fore and an aft direction.

Variation 11 may include a product as set forth in any of Variations 1-10 further comprising a programmable logic controller attached to the actuator to determine a speed and a timing of the stroke

Variation 12 may include a product as set forth in any of Variations 1-11 wherein a mechanical device is attached to the stroke slide device.

Variation 13 may include a product as set forth in any of Variations 1-12 wherein the mechanical device is attached to the mounting plate.

Variation 14 may include a product comprising: an adjustable slide system comprising: an actuator; a mounting block attached to the actuator; a slide bar attached to the mounting block; a mounting plate attached to the mounting block; and a rear stop bar attached to the mounting plate.

Variation 15 may include a method comprising: providing an adjustable stroke slide device comprising: a frame; a first and a second shock absorber coupled to opposing ends of the frame; a first and a second rail system coupled to opposing sides of the frame; an adjustable slide bar system interposed between the first and the second rail, wherein the adjustable slide bar system comprises an actuator, a mounting block attached to the actuator; a slide bar attached to the mounting block; a mounting plate attached to the first and the second rail system and the mounting block; and a rear stop bar attached to the mounting plate; driving the mounting block, slide bar, mounting plate, and rear stop block in a fore and aft direction with the actuator in order to control the stroke; adjusting the stroke by cutting the slide bar a first length to provide a first stroke; and cutting the slide bar to a second length to provide a second stroke.

Variation 16 may include a method as set forth in Variation 15 further comprising controlling a speed and a timing of the stroke by attaching a programmable logic controller to the actuator.

Variation 17 may include a method as set forth in any of Variations 15-16 further comprising providing a first cover to protect the adjustable stroke slide device from contaminants.

Variation 18 may include a method as set forth in any of Variations 15-17 further comprising providing a second cover to protect the adjustable stroke slide device from contaminants.

Variation 19 may include a method as set forth in any of Variations 15-18 further comprising controlling the stroke of a mechanical device using the adjustable stroke slide device.

The above description of select variations within the scope of the invention is merely illustrative in nature and, thus, variations or variants thereof are not to be regarded as a departure from the spirit and scope of the invention.

1. A product comprising:
a stroke slide device comprising:
a frame;
a first and a second shock absorber coupled to opposing ends of the frame;
a first and a second rail system coupled to opposing sides of the frame;
an adjustable slide bar system interposed between the first and the second rail; and
a mounting plate coupled to the first and second rail systems and the adjustable slide bar system.

2. The product of claim 1 wherein the frame comprises a base plate, a front plate, a rear plate, a first side plate, and a second side plate;
wherein the front plate and the rear plate are attached to opposing ends of the base plate; and wherein the first side plate and the second side plate are attached to opposing sides of the front plate and the rear plate.

3. The product of claim 1 wherein the adjustable slide system comprises an actuator;
a mounting block attached to the actuator;
a slide bar attached to the mounting block;
a mounting plate attached to the first and the second rail systems and the mounting block; and
a rear stop bar attached to the mounting plate.

4. The product of claim 3 wherein the first and the second rail systems each include at least one linear bearing, and wherein the mounting plate is attached to the at least one linear bearing on each of the first and the second rail systems.

5. The product of claim 3 wherein the slide bar comprises a first end and a second end, and wherein the second end comprises a cutout which is constructed and arranged to impact a shock absorber.

6. The product of claim 1 wherein the first and second rail systems are dry lubricated rails.

7. The product of claim 1 wherein the adjustable slide bar system is constructed and arranged to control the stroke of a mechanical device.

8. The product of claim 1 further comprising a first cover.

9. The product of claim 8 further comprising a second cover.

10. The product of claim 3 wherein the actuator drives the mounting block, slide bar, mounting plate, and rear stop bar in a fore and an aft direction.

11. The product of claim 7 further comprising a programmable logic controller attached to the actuator to control the speed and a timing of the stroke.

12. The product of claim 1 wherein a mechanical device is attached to the stroke slide device.

13. The product of claim 12 wherein the mechanical device is attached to the mounting plate.

14. A product comprising:
an adjustable slide system comprising:
an actuator;
a mounting block attached to the actuator;
a slide bar attached to the mounting block;
a mounting plate attached to the mounting block; and
a rear stop bar attached to the mounting plate.

15. A method comprising:
providing an adjustable stroke slide device comprising:
a frame;
a first and a second shock absorber coupled to opposing ends of the frame;
a first and a second rail system coupled to opposing sides of the frame;
an adjustable slide bar system interposed between the first and the second rail, wherein the adjustable slide bar system comprises an actuator, a mounting block attached to the actuator;
a slide bar attached to the mounting block; a mounting plate attached to the first and the second rail system and the mounting block; and a rear stop bar attached to the mounting plate;
driving the mounting block, slide bar, mounting plate, and rear stop block in a fore and aft direction with the actuator in order to control the stroke;
adjusting the stroke by cutting the slide bar a first length to provide a first stroke; and
cutting the slide bar to a second length to provide a second stroke.

16. The method of claim 15 further comprising controlling a speed and a timing of the stroke by attaching a programmable logic controller to the actuator.

17. The method of claim 15 further comprising providing a first cover to protect the adjustable stroke slide device from contaminants.

18. The method of claim 17 further comprising providing a second cover to protect the adjustable stroke slide device from contaminants.

19. The method of claim 15 further comprising controlling the stroke of a mechanical device using the adjustable stroke slide device.
